(19) United States
(12) Patent Application Publication
(10) Pub. No.: US 2023/0163834 A1
(43) Pub. Date: May 25, 2023

(54) BEAM SWITCHING FOR HIGH ALTITUDE PLATFORM STATIONS (HAPS)

(71) Applicant: NOKIA TECHNOLOGIES OY, Espoo (FI)

(72) Inventors: Gilsoo LEE, Lisle, IL (US); Tzu-Chung HSIEH, Hoffman Estates, IL (US); Jie CHEN, Naperville, IL (US)

(21) Appl. No.: 17/532,153

(22) Filed: Nov. 22, 2021

(51) Int. Cl. H04B 7/185

(52) U.S. Cl. CPC H04B 7/18504

(57) ABSTRACT

Systems, methods, apparatuses, and computer program products for switching beams on/off for high altitude platform stations (HAPS) are provided. One method may include selecting a beam on/off pattern from one or more beam on/off patterns for a high altitude platform station (HAPS) and a rotation period for the beam on/off pattern, based at least on flight information of the high altitude platform station (HAPS) and user equipment (UE) traffic load information. The method may also include transmitting, to one or more user equipment (UEs), an indication of beam switching on/off operation comprising at least one of the selected beam on/off pattern, a pattern rotation speed, and a reference time slot for a start of the selected beam on/off pattern. The method may then include initiating the beam switching on/off operation.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for switching beams for high altitude platform stations (HAPS).

### BACKGROUND

Examples of mobile or wireless telecommunication systems may include the Universal Mobile Telecommunications System (UNITS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mNITC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus including at least one processor and at least one memory comprising computer program code. The at least one memory and computer program code may be configured, with the at least one processor, to cause the apparatus at least to select a beam on/off pattern from one or more beam on/off patterns for a high altitude platform station (HAPS) and a rotation period for the beam on/off pattern, based at least on flight information of the high altitude platform station (HAPS) and user equipment (UE) traffic load information. The at least one memory and computer program code may be further configured, with the at least one processor, to cause the apparatus at least to transmit, to one or more user equipment (UEs), an indication of beam switching on/off operation comprising at least one of the selected beam on/off pattern, a pattern rotation speed, and a reference time slot for a start of the selected beam on/off pattern, and to initiate the beam switching on/off operation.

An embodiment may be directed to a method including selecting a beam on/off pattern from one or more beam on/off patterns for a high altitude platform station (HAPS) and a rotation period for the beam on/off pattern, based at least on flight information of the high altitude platform station (HAPS) and user equipment (UE) traffic load information. The method may also include transmitting, to one or more user equipment (UEs), an indication of beam switching on/off operation comprising at least one of the selected beam on/off pattern, a pattern rotation speed, and a reference time slot for a start of the selected beam on/off pattern, and initiating the beam switching on/off operation.

An embodiment may be directed to an apparatus including means for selecting a beam on/off pattern from one or more beam on/off patterns for a high altitude platform station (HAPS) and a rotation period for the beam on/off pattern, based at least on flight information of the high altitude platform station (HAPS) and user equipment (UE) traffic load information. The apparatus may also include means for transmitting, to one or more user equipment (UEs), an indication of beam switching on/off operation comprising at least one of the selected beam on/off pattern, a pattern rotation speed, and a reference time slot for a start of the selected beam on/off pattern, and means for initiating the beam switching on/off operation.

An embodiment may be directed to an apparatus including at least one processor and at least one memory comprising computer program code. The at least one memory and computer program code may be configured, with the at least one processor, to cause the apparatus at least to receive, from a network node, an indication of beam switching on/off operation comprising at least one of a selected beam on/off pattern, a pattern rotation speed, and a reference time slot for a start of the selected beam on/off pattern, and to infer, from the indication of the beam switching on/off operation, on/off durations of the selected beam on/off pattern.

An embodiment may be directed to a method including receiving, from a network node, an indication of beam switching on/off operation comprising at least one of a selected beam on/off pattern, a pattern rotation speed, and a reference time slot for a start of the selected beam on/off pattern, and inferring, from the indication of the beam switching on/off operation, on/off durations of the selected beam on/off pattern.

An embodiment may be directed to an apparatus including means for receiving, from a network node, an indication of beam switching on/off operation comprising at least one of a selected beam on/off pattern, a pattern rotation speed, and a reference time slot for a start of the selected beam on/off pattern, and means for inferring, from the indication of the beam switching on/off operation, on/off durations of the selected beam on/off pattern.

### BRIEF DESCRIPTION OF THE DRAWINGS

For proper understanding of example embodiments, reference should be made to the accompanying drawings, wherein:

FIG. 1 illustrates an example of a HAPS deployment scenario, according to an embodiment;

FIG. 2 illustrates the different beams observed by a UE over a certain time period, according to an embodiment;

FIG. 3 illustrates an example depicting that energy saving is proportional to the portion of switched-off beams, according to an embodiment;

FIG. 4 illustrates an example of a method for beam switching on/off operation, according to some embodiments;

FIG. 5 illustrates examples of symmetric beam on/off patterns with a different number of on beams, according to an embodiment;

FIG. 6 illustrates an example of a beam on/off pattern that can be repeated over time slots where the time unit can be varied depending on the rotating speed, according to an embodiment;

FIG. 7 illustrates an example that different ON beams (patterns) can appear over time-, according to an embodiment;

FIG. 8 illustrates an example diagram depicting the decision making to change the on/off beam pattern when the traffic arrival rate increases, according to an embodiment;

FIG. 9 illustrates an example of decision making to change the on/off beam pattern when traffic latency increases and UE wants to reduce the latency, according to an embodiment;

FIG. 10 illustrates an example where on/off scheduling is not used during a synchronization signal block (SSB) transmission period, according to an embodiment;

FIG. 11 illustrates an example of a beam-specific bandwidth part (BWP) configuration, according to an embodiment;

FIG. 12 illustrates an example flow diagram of a method, according to an embodiment;

FIG. 13 illustrates an example flow diagram of a method, according to an embodiment;

FIG. 14A illustrates a block diagram of an apparatus, according to an embodiment; and

FIG. 14B illustrates a block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for switching beams on/off for HAPS energy saving, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

A high altitude platform station (HAPS) may refer to an aircraft platform including a radio station that is flying, for example, at an altitude of 20-50 km in the stratosphere. HAPS can potentially be used to provide fixed broadband connectivity for end users, and to provide transmission links between the mobile and core networks for backhauling traffic. Therefore, HAPS can provide a large coverage area on the ground. For instance, the coverage of a HAPS may be about 100 km in radius due to the high altitude. As a result, HAPS can enable wireless deployment in remote areas, such as coastal, mountainous, and desert areas.

The aerial platform for HAPS can be an unmanned aircraft with navigation capability and communication link to the ground station for command and control. Moreover, in some embodiments, HAPS can be a lightweight, solar-powered aircraft. By exploiting the energy harvesting technologies, renewable energy sources such as solar energy can be used as a power source for the HAPS system. Since the communication systems on HAPS can also use renewable energy, energy-saving management can be applicable to HAPS deployment scenarios. Therefore, HAPS can be continuously operating for several months once deployed. In short, HAPS can have a lower operational cost in providing a cellular coverage area when compared to other communication systems, such as satellites and terrestrial networks.

In 5G communications systems, HAPS is one of the potential platforms for 5G new radio (NR) base stations. For instance, HAPS can perform the functionalities of a gNB in 5G. Therefore, HAPS is expected to provide mobile broadband service, massive IoT connectivity, and backhauling for terrestrial and non-terrestrial networks. Deploying aerial base stations, such as HAPS, has been considered to overcome the coverage limitation of terrestrial networks. UEs located outside the terrestrial network's coverage can be served by the HAPS deployed in remote areas such as oceans, mountains, and deserts. Also, when a terrestrial network is disabled in emergency and disaster scenarios, HAPS can be deployed as a non-terrestrial network (NTN) to provide connectivity in a disaster-stricken area.

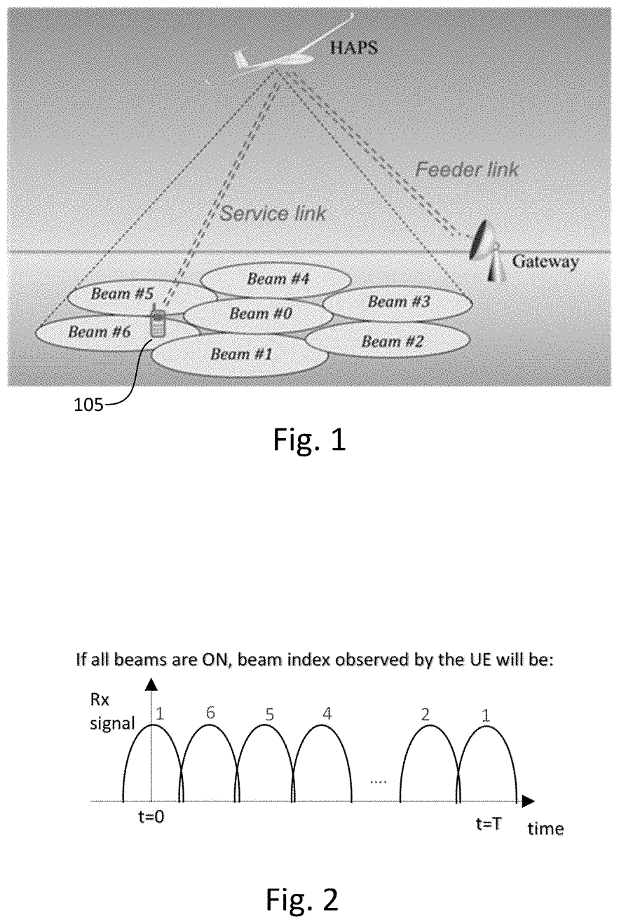

To deploy NTN with HAPS, the flight platform should stay above the targeting coverage area. To this end, HAPS can fly in a circular flight path above the service area. FIG. 1 illustrates an example of a HAPS deployment scenario where the flight trajectory is a circular path to provide cellular coverage for a certain area. In that case, FIG. 2 illustrates the different beams observed by the UE over the time period when the UE is located at the location 105 marked in FIG. 1. In particular, FIG. 2 shows that UE may observe the different beam indices of the beams transmitted by the HAPS. As HAPS increases the flight speed while maintaining the circular flight path, the UE will be in each beam coverage for a shorter time period, thus experiencing fast beam coverage change.

The benefits of deploying HAPS can include providing a large coverage area for an extended time period with a flexible deployment capability. To exploit the benefits, it would be desirable to minimize the energy consumption of the HAPS system. Also, HAPS generally relies on an energy storage system with limited size. Therefore, optimizing the energy consumption is desirable in order to extend an uninterrupted operation period of HAPS.

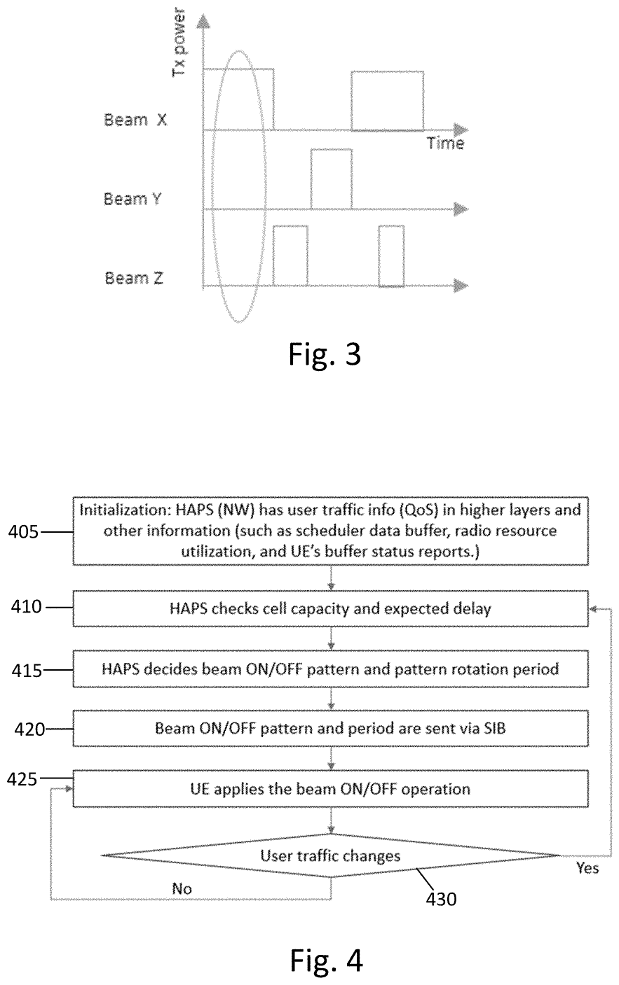

Terrestrial networks (TN) have adopted energy-saving methods such as the base station ON/OFF operations. For instance, it may be possible to reduce power consumption by switching OFF the beams, as illustrated in the example of FIG. 3. More specifically, FIG. 3 depicts that energy saving is proportional to the portion of switched-off beams. For instance, in the example of FIG. 3, if beams Y and Z are temporarily turned off, the transmit power can be reduced by up to 66%, assuming the transmit power of beams is identical. However, the existing TN energy-saving methods do not consider the flight pattern of HAPS, where the beam/cell coverage would move over time. Therefore, the unique features of HAPS, such as flight patterns, should be considered when designing beam switching methods for HAPS.

As will be discussed in detail below, certain example embodiments provide systems and methods for energy-efficient HAPS operation where the beams may be activated and deactivated based on the HAPS flight pattern.

For instance, an example embodiment introduces a practical beam ON/OFF method for a HAPS platform, which may include using different beam ON/OFF patterns and rotating the beam ON/OFF pattern adaptive to HAPS motion and/or UE traffic status. Some example embodiments may take into consideration a real-world flight pattern such as a small radius circular flight pattern. As such, certain embodiments can account for the HAPS flight pattern, as well as beam-array configuration. According to certain example embodiments, a HAPS can proactively optimize and decide the beam ON/OFF pattern and its rotation speed. For example, an embodiment may first decide the beams be switched ON/OFF periodically, and then the network may schedule the UE to transmit/receive data at the most suitable time slots.

More specifically, certain example embodiments provide a practical beam switching ON/OFF method for a HAPS platform including a beam ON/OFF pattern and rotation that is adaptive to the HAPS flight path, a HAPS antenna configuration, and/or a UE traffic pattern. In certain embodiments, the energy consumption can be reduced by proactively turning off a subset of beams of the HAPS antenna array and rotating the ON beam pattern according to the UE traffic load information and HAPS motion.

In an embodiment, the beam switching on/off patterns may be predetermined by HAPS. For instance, a symmetric pattern can be used for interference mitigation. According to an embodiment, HAPS may select one of the beam ON/OFF patterns. The selected beam ON/OFF pattern may be rotated to prevent a coverage hole, and the HAPS may determine the rotation speed of the ON/OFF pattern, e.g., depending on the flight speed of the HAPS in a circular trajectory and/or a data traffic latency requirement.

According to some embodiments, traffic load information may be used to determine the ON/OFF pattern and the pattern rotation period. At HAPS, the traffic information can be inferred from the scheduler's data buffer, radio resource utilization, and/or a UE's buffer status reports (BSR). Also, HAPS may have knowledge on the flight trajectory. By using both traffic load and flight information, HAPS can select the beam ON/OFF pattern and rotation speed that maximize the rate and/or minimize latency (e.g., satisfying the traffic data quality of service (QoS)). Also, the network can decide the beam ON/OFF pattern by considering the HAPS battery energy level.

In certain embodiments, HAPS may broadcast information on the beam switching ON/OFF operation including, for example, beam pattern, pattern rotation speed, and/or pattern start reference time in a system information block (SIB). The UE can use this information to infer the ON/OFF durations of the selected beam and transition between discontinuous reception (DRX) active and inactive modes in the radio resource control (RRC) connected state according to the beam's ON/OFF status. As a result, certain time slots may be blocked when the beam is switched OFF and, in these blocked slots, the UE may skip monitoring physical downlink control channel (PDCCH). UEs may have different blocked time slots depending on the UE location.

According to an embodiment, multiple beam patterns may be used at different time slots. For example, if the traffic load is reduced, the network can select a beam pattern with a lesser number of ON beams. Also, if a ground UE needs to reduce latency, HAPS can increase the beam rotation speed. Therefore, the combination of multiple beam patterns and variable beam rotation speeds enables HAPS to adjust the cell capacity to satisfy a dynamically changing traffic load and the required data latency.

In one embodiment, while synchronization signal (SS)/physical broadcast channel (PBCH) blocks (SSB) are transmitted, the beam ON/OFF pattern is not applied over the frequency resources used by these signals. Therefore, the SSB beams are turned ON at the time of SS/PBCH blocks transmission. When transmitting physical random access channel (PRACH) in the random access procedure, the UE can select a random access channel (RACH) occasion corresponding to the intended SSB beam when the SSB beam is turned on.

Additionally, in an embodiment, the beam switching ON/OFF operation can use a beam-specific bandwidth part (BWP) to mitigate the co-channel interference. For example, adjacent beams may be assigned to non-overlapping BWP. A wider BWP may be assigned to beams with higher traffic load.

In an example embodiment, a smart scheduling method is provided to decide the timing of switching on/off each beam. FIG. 4 illustrates an example of a method for beam switching on/off operation, according to some embodiments. As illustrated in the example of FIG. 4, at initialization as shown at 405, the HAPS or network (NW) may have user traffic information (e.g., QoS) in higher layers and other information, such as the scheduler's data buffer, radio resource utilization and/or UE's buffer status reports. The NW or HAPS may also have knowledge on the parameters related to HAPS motion, including current and future (estimated) trajectory, speed, pattern, and/or flight plan.

According to an embodiment, the on/off state of a HAPS beam may be determined based at least on the HAPS flight and load information. In an embodiment, to decide the beam on/off pattern, the NW or HAPS may also consider the user data traffic load, which can be inferred from the scheduler's data buffer, radio resource utilization, and the UE's buffer status reports. To decide the beam rotation speed, the NW or HAPS may consider the delay budget for the data traffic QoS. In some examples, the NW or HAPS can also decide the beam ON/OFF pattern by considering the HAPS battery energy level, since the energy consumption can affect to HAPS battery level and flight duration.

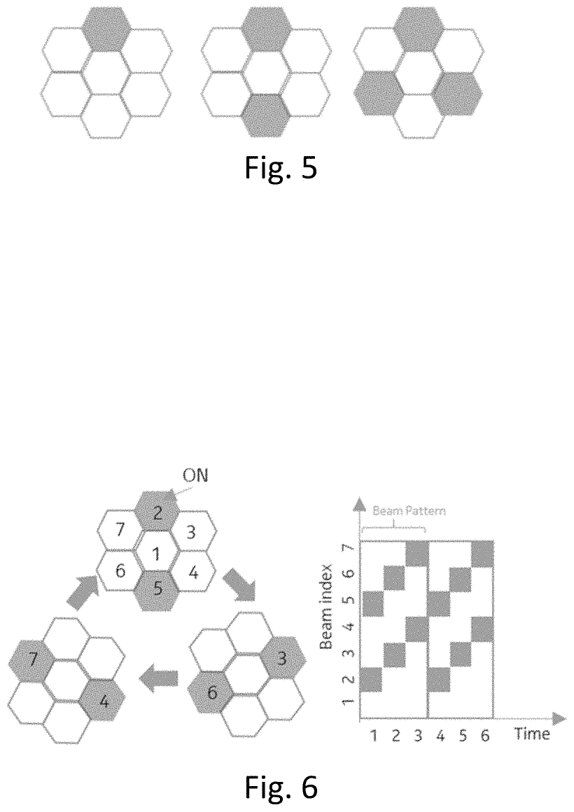

In certain embodiments, different beam switching on/off patterns can be defined and used by HAPS so that one of the on/off patterns is adaptively selected based on the flight pattern and the UE traffic. For instance, FIG. 5 shows examples of symmetric beam on/off patterns with a different number of ON beams, which are shown as shaded. The symmetric pattern can be helpful for reducing co-channel interference even if the carrier frequency is fully reused.

According to some example embodiments, the beam ON/OFF pattern may be rotated to provide continuous service coverage without leaving coverage holes. If the flight trajectory is a circular path, a rotation speed of HAPS wₕ (given in radian per second (rad/s) units) is a parameter determined from HAPS flight speed and flight radius. In addition to the rotation of HAPS flight, the beam ON/OFF pattern may be rotated with a speed wᵣ rad/s, as shown in the example of FIG. 6. More specifically, FIG. 6 illustrates an example of a beam on/off pattern that can be repeated over time slots where the time unit can be varied depending on the rotating speed. As a result, the effective rotation speed of the beam pattern, w_{b}, can be given by the sum of beam rotation speed and the rotation speed of the HAPS, i.e., w_{b}=wᵣ+wₕ. Therefore, it is possible to provide continuous coverage for the ground UE devices, thus minimizing coverage outage.

In certain embodiments, once HAPS defines the different beam on/off patterns, the HAPS may select (i) a beam on/off pattern and (ii) the rotation period of the beam on/off pattern. In an embodiment, by using the flight and load information, as illustrated in FIG. 4 at 410, HAPS may check ‘cell capacity’ and ‘expected delay’ if the beams are turned off with different patterns and rotation speeds. At 415, the NW or HAPS may select the beam on/off pattern and the pattern rotation speed. For example, as shown at 415, HAPS may select the beam on/off pattern and rotation period that satisfies the cell capacity and traffic latency while minimizes its power consumption in beam operation.

In addition, according to certain embodiments, the NW can use load information to decide on the ON/OFF pattern. For instance, more ON beams may be configured when UE density is high. Also, the beam rotation speed may be increased if the traffic arrival rate is high. Moreover, NW can consider HAPS battery energy level. If the store energy level is low at the HAPS, the pattern with fewer ON beams can be configured.

As illustrated in the example of FIG. 4, at 420, the decision on the beam switching on/off operation can be shared with UE, e.g., via SIB broadcast. For example, the HAPS may send a SIB including a ‘one-bit indication’ to activate the beam switching ON/OFF operation. In an embodiment, the SIB may also contain the beam ON/OFF pattern, the pattern's rotation speed (or periodicity), and/or a reference time slot for the start of the ON/OFF pattern. Based on this information, the UE can determine the ON/OFF status of the selected SSB beam from its RSRP measurements. When transmitting PRACH, the UE may use a RACH occasion corresponding to the selected SSB beam in a time slot when the beam is ON.

If the one-bit indication is set by the HAPS, the existing DRX operation running on UE can be modified to block the transmission at the certain time slots when the beam is switched OFF. Therefore, each UE may stay in inactive mode at the different blocked time slots depending on UE location. To block the time slots in the DRX operation, the DRX parameters may be matched to the beam ON/OFF period. In that case, the ‘onDurationTimer’ may be set to the ON duration of the UE's serving beam, and the ‘DRX Cycle’ may be matched to the beam rotation period. For example, as illustrated in the example of FIG. 6, if the UE is initially associated with beam 2, the UE can calculate the ON period of beam 2. Then, the ‘onDurationTimer’ places the UE in active mode at the time slot indexes {1, 4, 7, . . . }. Therefore, when the UE moves back to active mode in DRX, the UE will be in the coverage of ON beam (note that the beam ON/OFF period can be represented in the format of the number of subframes/slots). In this way, the UE can just monitor physical downlink control channel (PDCCH) in the slots associated with DRX active mode.

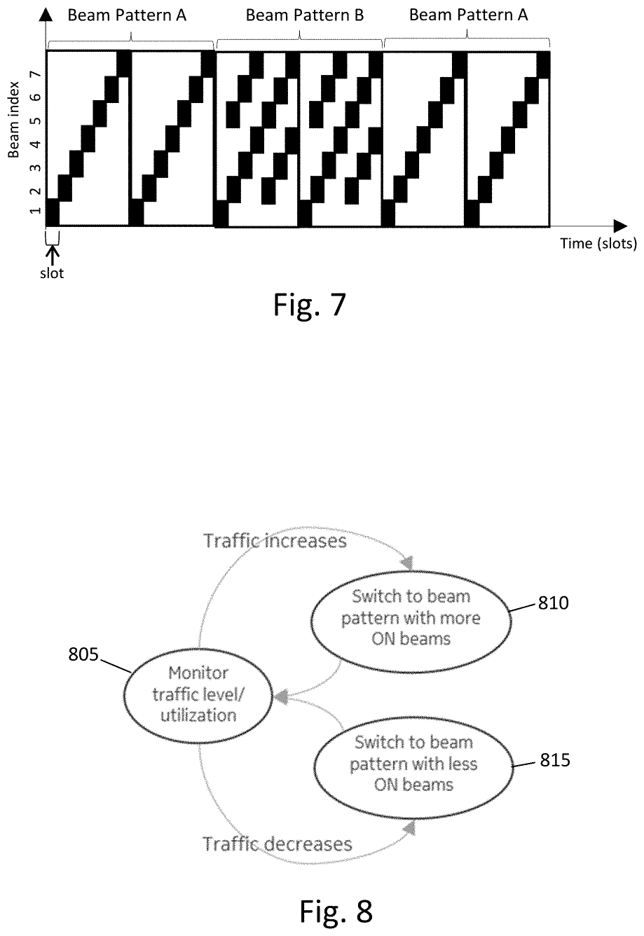

After the HAPS sends an indication to the UE, at 425, the HAPS may initiate beam switching ON/OFF operation, and the aforementioned procedures may be periodically repeated to evaluate and update the beam ON/OFF status. For example, at 430, it may be determined whether user traffic changes have occurred and, if so, the method may return to procedure 410 to check cell capacity and expected delay. Also, in an embodiment, when the beam ON/OFF pattern is rotated, multiple beam patterns can be used at different time slots, as shown in the example of FIG. 7. In particular, the example of FIG. 7 illustrates that different ON beams (patterns) can appear over time. For example, when the UE traffic level dynamically changes over time, if a traffic level is reduced, the NW can select a beam pattern with less number of ON beams. When the multiple beam on/off patterns are sequentially used, the information about the active slots for a beam/cell may be sent to UE. For instance, in the example of FIG. 7, the different beam patterns can be rotated in unit of slots, respectively. Therefore, the NW can schedule UE on the slots having the most suitable beam for the UE.

In some embodiments, multiple beam ON/OFF patterns may be adaptively selected. When the beam pattern changes at the time slots, the following two examples show the decision logic used to change the beam pattern. FIG. 8 illustrates an example diagram depicting the decision making to change the on/off beam pattern when the traffic arrival rate increases, according to an embodiment. In the example of FIG. 8, the beam on/off pattern changes depending on whether the traffic increases or decreases. To this end, FIG. 8 illustrates, at 805, that the HAPS first observes traffic levels based on UE reports and monitors network utilization. Then, if the traffic arrival rate increases, at 810, the HAPS can select a pattern where more beams are simultaneously turned ON. Otherwise, if the traffic arrival rate decreases, at 815, the HAPS can turn OFF more beams by selecting a pattern with fewer ON beams.

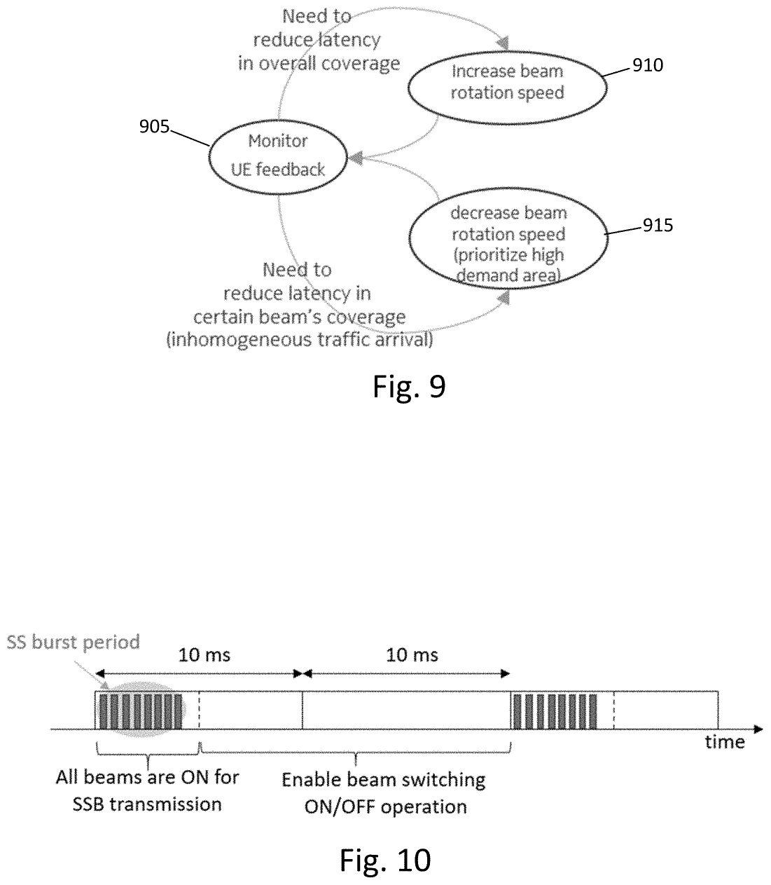

According to an embodiment, if a ground UE needs to reduce latency, the HAPS can increase the beam rotation speed. FIG. 9 illustrates an example of decision making to change the on/off beam pattern when traffic latency increases and UE wants to reduce the latency, according to an embodiment. The example of FIG. 9 shows that the selection of beam pattern depends on the latency. As illustrated in FIG. 9, at 905, the NW can monitor the UE feedback, including the latency or other similar metrics such as quality of service. If the NW detects the increment of latency in all beam coverage areas, at 910, the HAPS can increase the rotation speed of the beam pattern. With a high beam rotation speed, the beams will be turned on/off more frequently so that each UE is able to access with lower latency. In another case, if HAPS detects a sudden increment of latency at a certain beam coverage area, at 915, the beam rotation speed is lowered so that the ON beam can remain over the high traffic area during an extended time period.

The beam on/off pattern may not apply to SS/PBCH blocks transmissions. In the periodic SS bursts, all the SSB beams are turned on to transmit SS/PBCH blocks in the allocated PRBs even if some of the beams are in the off period for user data transmission. As a result, there will be no impact on the UE's initial access and channel quality measurements. FIG. 10 illustrates that on/off scheduling is not applied to the SSB transmission, according to an embodiment. In other words, FIG. 10 illustrates that SS/PBCH blocks of all the SSB beams are transmitted regardless of beam On/Off status.

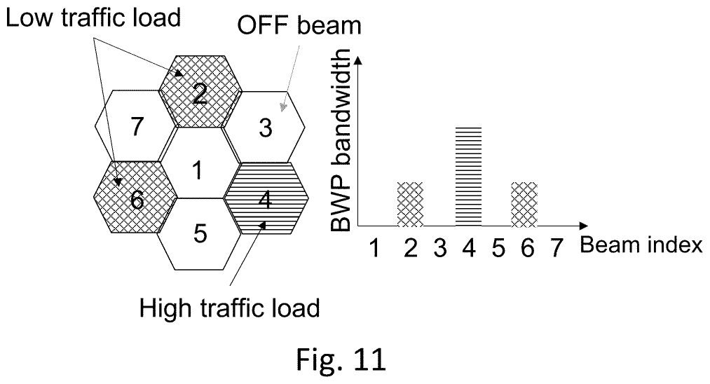

Additionally, in some embodiments, when beams are scheduled to on/off status, each beam can use a different BWP. Non-overlapping or partially overlapped BWP may be allocated to adjacent beams in order to reduce the co-channel interference. The bandwidth of BWP may be considered with the traffic load of each beam such that a wider BWP is assigned to the beams with heavier loads. FIG. 11 illustrates an example of the beam-specific BWP configuration, according to an embodiment. The example of FIG. 11 illustrates the BWP of on beam is allocated depending on the traffic load of each beam. In the example of FIG. 11, beam 4 is allocated to a larger BWP than beams 2 and 6, since beam 4 has a higher traffic load than beams 2 and 6.

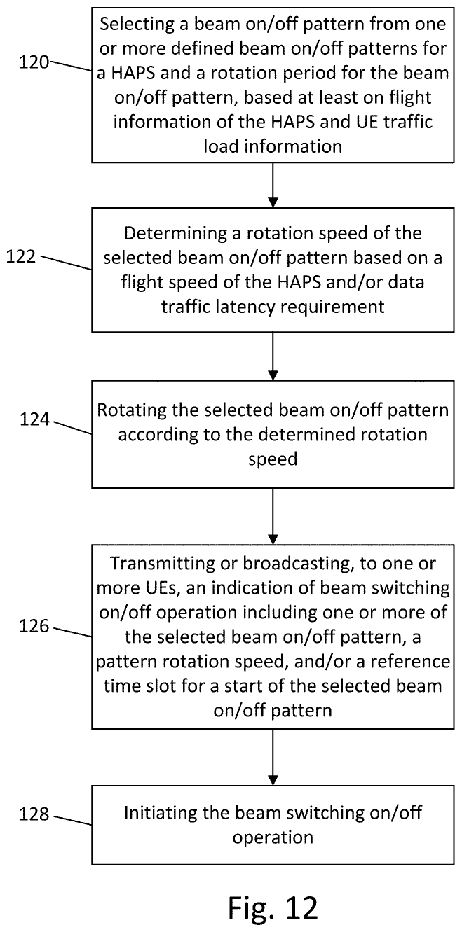

FIG. 12 illustrates an example flow diagram of a method of switching beams on/off for HAPS, according to one embodiment. In certain example embodiments, the flow diagram of FIG. 12 may be performed by a network entity or network node in a communications system, such as LTE or 5G NR. In some example embodiments, the network entity performing the method of FIG. 12 may include or be included in a base station, access node, node B, eNB, gNB, gNB-DU, gNB-CU, NG-RAN node, 5G node, transmission-reception points (TRPs), high altitude platform stations (HAPS), relay station, or the like.

As illustrated in the example of FIG. 12, the method may include, at 120, selecting a beam on/off pattern from one or more beam on/off patterns for a HAPS and a rotation period for the beam on/off pattern, based at least on flight information of the HAPS and UE traffic load information. According to certain embodiments, the one or more beam on/off patterns may include different beam switching on/off patterns predefined or predetermined by the HAPS. For instance, symmetric patterns may be defined to be used for interference mitigation. In some embodiments, the flight information may include one or more of a trajectory, speed, pattern, and/or flight plan for the high altitude platform station (HAPS). According to an embodiment, the UE traffic load information may be inferred from a scheduler's data buffer, radio resource utilization, and/or a user equipment's buffer status report. In an embodiment, the selecting 120 may include selecting the beam on/off pattern that satisfies cell capacity and traffic latency requirements while minimizing power consumption of beam operation at the HAPS. According to an embodiment, the HAPS battery energy level may also be considered when selecting the beam on/off pattern.

As further illustrated in the example of FIG. 12, the method may include, at 122, determining a rotation speed of the selected beam on/off pattern based on the flight information of the HAPS and/or data traffic latency requirement. In some embodiments, the method may include, at 124, rotating the selected beam on/off pattern according to the rotation speed to provide continuous service coverage without coverage holes.

In the example of FIG. 12, the method may include, at 126, transmitting or broadcasting, to one or more UEs, an indication of beam switching on/off operation including one or more of the selected beam on/off pattern, a pattern rotation speed, and/or a reference time slot for a start of the selected beam on/off pattern. In one embodiment, the transmitting 126 may include transmitting a one-bit indication to activate the beam switching on/off operation. For example, in an embodiment, the one-bit indication may be transmitted in a SIB. According to certain embodiments, the method may then include, at 128, initiating the beam switching on/off operation.

In some embodiments, the multiple beam patterns may be used at different time slots. For example, if the UE traffic load is reduced, then a beam pattern with a lesser number of on beams may be selected. According to some embodiments, the method may include changing the selected beam on/off pattern depending on whether traffic from the one or more UEs increases or decreases. For instance, as discussed above, with respect to FIG. 8, the method may include monitoring traffic levels based on UE reports and monitoring network utilization. If the monitored traffic arrival rate increases, the selecting 120 may include selecting a pattern where more beams are simultaneously turned ON. Otherwise, if the monitored traffic arrival rate decreases, the selecting 120 may include selecting a pattern with fewer ON beams. In further example embodiments, the method may include changing the beam rotation speed based on a change in latency required at the one or more UEs. For instance, as discussed above, with respect to FIG. 9, if one of the UEs desires to reduce latency, the determining 122 may include determining to increase the rotation speed of the beam. Alternatively, if an increase in latency is detected, then the determining 122 may include determining to decrease the rotation speed of the beam so that the on beam can remain over a high traffic area for an extended time period.

According to some embodiments, control signals for initial access or channel quality measurement including at least SS/PBCH blocks may be transmitted regardless of a status of the selected beam on/off pattern. In other words, according to an embodiment, while SS/PBCH blocks are transmitted, the selected beam on/off pattern is not applied to the resource blocks occupied by SS/PBCH. Therefore, SSB beams are turned on at the time of transmission of SS/PBCH blocks. Further, in certain embodiments, the beam switching on/off operation can use a beam-specific BWP to mitigate co-channel interference. For example, adjacent beams may be assigned to non-overlapping BWP, and a wider BWP may be assigned to beams with higher traffic load.

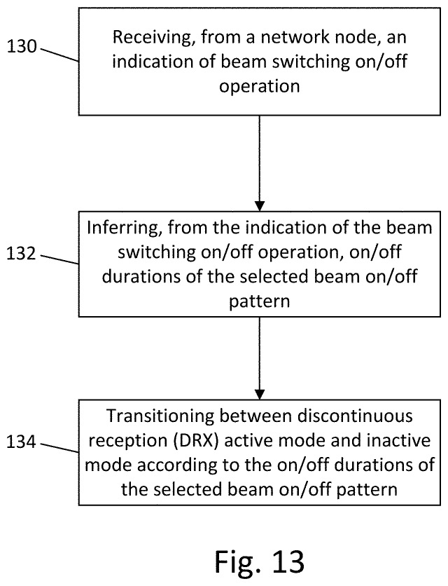

FIG. 13 illustrates an example flow diagram of a method of switching beams on/off for HAPS, according to an example embodiment. In certain example embodiments, the flow diagram of FIG. 13 may be performed by a communication device in a communications system, such as LTE or 5G NR. For instance, in some example embodiments, the communication device performing the method of FIG. 13 may include a UE, sidelink (SL) UE, wireless device, mobile station, IoT device, UE type of roadside unit (RSU), other mobile or stationary device, or the like.

As illustrated in the example of FIG. 13, the method may include, at 130, receiving, from a network node, such as HAPS, an indication of beam switching on/off operation. The indication of the beam switching on/off operation may include one or more of a selected beam on/off pattern, a pattern rotation speed, and/or a reference time slot for a start of the selected beam on/off pattern. According to certain embodiments, the receiving 130 may include receiving a one-bit indication to activate the beam switching on/off operation. For instance, in an embodiment, the one-bit indication may be received in a SIB. In an embodiment, the method may include, at 132, inferring, from the indication of the beam switching on/off operation, on/off durations of the selected beam on/off pattern. According to some embodiments, the method may include, at 134, transitioning between discontinuous reception (DRX) active mode and inactive mode in RRC connected state according to the on/off durations of the selected beam on/off pattern. As a result, certain time slots may be blocked when the beam is switched off. The UE may have different blocked time slots from other UEs depending on the UE location.

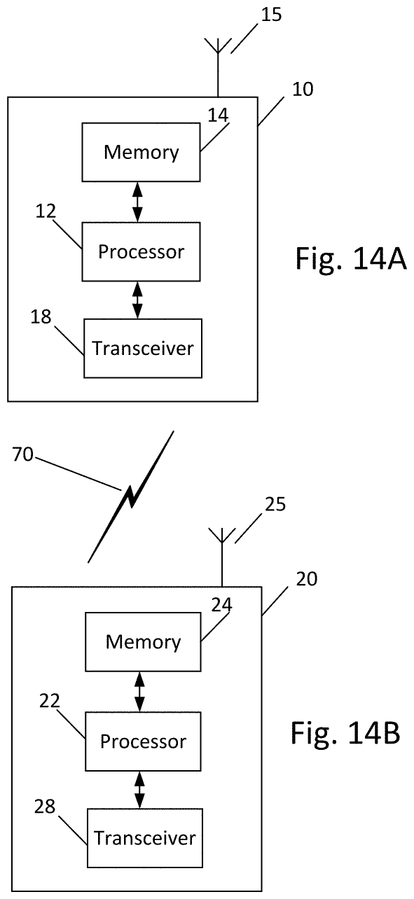

FIG. 14A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, RRH, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a substantially same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 14A.

As illustrated in the example of FIG. 14A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 14A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 10 may be or may be a part of a network element or RAN node, such as a base station, access point, Node B, eNB, gNB, TRP, RRH, HAPS, IAB node, relay node, WLAN access point, satellite, or the like. In one example embodiment, apparatus 10 may be a HAPS or other aircraft having a radio node. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIG. 4, 8, 9 or 12, or any other method described herein. In some embodiments, as discussed herein, apparatus 10 may be configured to perform a procedure relating to switching beams on/off for HAPS, for example.

FIG. 14B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, CPE, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 14B.

As illustrated in the example of FIG. 14B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 14B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, CPE, or the like, for example. According to certain embodiments, apparatus 20 may be controlled by memory 24 and processor 22 to perform the functions associated with any of the embodiments described herein, such as one or more of the operations illustrated in, or described with respect to, FIG. 4, 8, 9 or 13, or any other method described herein. For example, in an embodiment, apparatus 20 may be controlled to perform a process relating to switching beams on/off for HAPS, as described in detail elsewhere herein.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, an advantage of certain embodiments is a reduction in the energy consumption of the HAPS. For example, the amount of energy saving can be proportional to the fraction of switched-off beams. In an embodiment, when beams are turned off, the increment of coverage outage can be prevented by adaptively changing the switching on/off pattern and its rotation speed. Accordingly, the use of certain example embodiments results in improved functioning of communications networks and their nodes, such as base stations, eNBs, gNBs, HAPS, and/or IoT devices, UEs or mobile stations, or the like.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

3GPP 3rd Generation Partnership Project

BWP Bandwidth Part

DRX Discontinuous Reception

ESM Energy Saving Management

gNB next-generation NodeB

HAPS High Altitude Platform Station

NR New Radio

NTN Non-terrestrial network

NW Network

RACH Random Access Channel

PBCH Physical Broadcast Channel

PRACH Physical Random Access Channel

RRM Radio Resource Management

SIB System Information Block

SS Synchronization Signal

TN Terrestrial network

UAV Unmanned Aerial Vehicles

UE User Equipment.

We claim:

1. An apparatus, comprising:
at least one processor; and
at least one memory comprising computer program code,
the at least one memory and computer program code configured, with the at least one processor, to cause the apparatus at least to perform:
selecting a beam on/off pattern from one or more beam on/off patterns for a high altitude platform station (HAPS) and a rotation period for the beam on/off pattern, based at least on flight information of the high altitude platform station (HAPS) and user equipment (UE) traffic load information;
transmitting, to one or more user equipment (UEs), an indication of beam switching on/off operation comprising at least one of the selected beam on/off pattern, a pattern rotation speed, and a reference time slot for a start of the selected beam on/off pattern; and
initiating the beam switching on/off operation.

2. The apparatus of claim 1, wherein the one or more beam on/off patterns comprise different beam switching on/off patterns predefined by the high altitude platform station (HAPS).

3. The apparatus of claim 1, wherein the flight information comprises at least one of a trajectory, speed, pattern, or flight plan for the high altitude platform station (HAPS).

4. The apparatus of claim 1, wherein the at least one memory and computer program code are configured, with the at least one processor, to cause the apparatus at least to perform:
determining a rotation speed of the selected beam on/off pattern based on the flight information of the high altitude platform station (HAPS) and data traffic latency requirement; and
rotating the selected beam on/off pattern according to the rotation speed to provide continuous service coverage without coverage holes.

5. The apparatus of claim 1, wherein the user equipment (UE) traffic load information is inferred from at least one of a scheduler's data buffer, radio resource utilization, or a user equipment's buffer status report.

6. The apparatus of claim 1, wherein the selecting comprises selecting the beam on/off pattern that satisfies cell capacity and traffic latency requirements.

7. The apparatus of claim 1, wherein the transmitting comprises transmitting a one-bit indication to activate the beam switching on/off operation.

8. The apparatus of claim 1, wherein the one or more beam patterns are used at different time slots.

9. The apparatus of claim 1, wherein the at least one memory and computer program code are configured, with the at least one processor, to cause the apparatus at least to perform:
changing the selected beam on/off pattern depending on whether traffic from the one or more user equipment (UEs) increases or decreases.

10. The apparatus of claim 4, wherein the at least one memory and computer program code are configured, with the at least one processor, to cause the apparatus at least to perform:
changing the beam rotation speed based on a change in latency required at the one or more user equipment (UEs).

11. The apparatus of claim 1, wherein control and reference signals for initial access and channel quality measurement comprising at least synchronization signal (SS) and physical broadcast channel (PBCH) blocks are transmitted regardless of a status of the selected beam on/off pattern.

12. The apparatus of claim 1, wherein the beam switching on/off operation uses a beam-specific bandwidth part to mitigate co-channel interference.

13. The apparatus of claim 1, wherein the apparatus comprises the high altitude platform station.

14. An apparatus, comprising:
at least one processor; and
at least one memory comprising computer program code,
the at least one memory and computer program code configured, with the at least one processor, to cause the apparatus at least to perform:
receiving, from a network node, an indication of beam switching on/off operation comprising at least one of a selected beam on/off pattern, a pattern rotation speed, and a reference time slot for a start of the selected beam on/off pattern; and
inferring, from the indication of the beam switching on/off operation, on/off durations of the selected beam on/off pattern.

15. The apparatus of claim 14, wherein the at least one memory and computer program code configured, with the at least one processor, to cause the apparatus at least to perform:
transitioning between discontinuous reception (DRX) active mode and inactive mode according to the on/off durations of the selected beam on/off pattern.

16. The apparatus of claim 14, wherein the receiving comprises receiving a one-bit indication to activate the beam switching on/off operation.

17. The apparatus of claim 14, wherein the apparatus comprises a user equipment.

18. A method, comprising:
receiving, from a network node, an indication of beam switching on/off operation comprising at least one of a selected beam on/off pattern, a pattern rotation speed, and a reference time slot for a start of the selected beam on/off pattern; and
inferring, from the indication of the beam switching on/off operation, on/off durations of the selected beam on/off pattern.

19. The method of claim 18, wherein the at least one memory and computer program code configured, with the at least one processor, to cause the apparatus at least to perform:
transitioning between discontinuous reception (DRX) active mode and inactive mode according to the on/off durations of the selected beam on/off pattern.

20. The method of claim 18, wherein the receiving comprises receiving a one-bit indication to activate the beam switching on/off operation.
